(19) United States
(12) Patent Application Publication
(10) Pub. No.: US 2008/0306899 A1
(43) Pub. Date: Dec. 11, 2008

(54) METHODS, APPARATUS, AND COMPUTER-READABLE MEDIA FOR ANALYZING CONVERSATIONAL-TYPE DATA

(76) Inventors: Michelle L. Gregory, Richland, WA (US); Stuart J. Rose, Richland, WA (US); Douglas V. Love, West Richland, WA (US); Anne Schur, Richland, WA (US)

Correspondence Address: BATTELLE MEMORIAL INSTITUTE;ATTN: IP SERVICES, K1-53, P. O. BOX 999, RICHLAND, WA, 99352, US

(21) Appl. No.: 11/759,803

(22) Filed: Jun. 7, 2007

(51) Int. Cl. G06F 17/30

(52) U.S. Cl. 707/1; 707/E17.001

(57) ABSTRACT

Methods, apparatus, and computer-readable media for analyzing conversational-type data by association of two or more types of extracted information in view of time are disclosed according to some aspects. In one embodiment, analysis of conversational-type data comprises identification of topical segments within the conversational-type data and linking of the topical segments with at least one other type of pertinent, extracted information. The linking can be based on a sequential order of utterances that compose, at least in part, the conversational-type data.

### STATEMENT REGARDING FEDERALLY SPONSORED RESEARCH OR DEVELOPMENT

This invention was made with Government support under Contract DE-AC0576RLO1830 awarded by the U.S. Department of Energy. The Government has certain rights in the invention.

### BACKGROUND

The ability to extract and summarize content from data is extremely valuable for making sense of vast amounts of data. As such, many tools exist to automatically categorize, cluster, and extract information from documents. However, these tools have traditionally not transferred well to data sources that are more conversational in nature. The issue exists because the underlying algorithms of many of these traditional tools are typically optimized for clean, content-rich, single-authored documents, which do not characterize conversational-type data. Therefore, given the plethora of conversational-type data sources, a need exists for computer-implemented methods, apparatus, and computer-readable media for quickly and accurately extracting and processing pertinent information from conversational-type data sources without having to cull them manually.

### DESCRIPTION OF DRAWINGS

Embodiments of the invention are described below with reference to the following accompanying drawings.

FIG. 1 is an illustration of a windowless topic segmentation technique according to one embodiment.

FIG. 2 is a block diagram depicting the process of analyzing conversational-type data according to one embodiment.

FIG. 3 is a depiction of a visualization of the analysis of conversational-type data according to one embodiment.

FIG. 4 is a diagram of an embodiment of an apparatus for analysis of conversational-type data.

FIG. 5 is a diagram of an exemplary software architecture appropriate for some embodiments of the present invention.

### DETAILED DESCRIPTION

At least some aspects of the disclosure provide apparatus, computer-readable media, and computer-implemented methods for analysis of conversational-type data by association of two or more types of extracted information in view of time. Exemplary analysis can comprise identification of topical segments within the conversational-type data and linking of the topical segments with at least one other type of pertinent, extracted information. The linking can be based on a sequential order of the utterances that compose, at least in part, the conversational-type data.

In some implementations, the linking of topical segments with other types of pertinent extracted information can provide users with the information and/or tools to identify topics or persons of interest, including who talked to whom, temporal associations of the discussion, entities that were discussed, etc. Furthermore, implementations can provide information and/or tools to isolate complex networks of information such as individuals who discussed the same topics, but never directly with one another. Accordingly, embodiments of the present invention can be implemented for a range of applications including, but not limited to, business intelligence, market analysis, customer service analysis, information analysis, etc.

As used herein, conversational-type data comprises a plurality of utterances and is typically, though not always, generated by a plurality of participants engaged in a dialogue or conversation. However, it can also include self-dialogue in some embodiments. Conversational-type data can be characterized by sparse content, typos, novel or new word usage, dynamic vocabularies, inconsistent conventions for punctuation, abbreviations, etc. Exemplary sources of conversational-type data can include, but are not limited to, chat logs, phone transcripts, multi-party meeting transcripts, instant messaging, usenet groups, and combinations thereof. Embodiments of the present invention can also be extended to address conversational-type data sources comprising blogs, email correspondence, and combinations thereof. In various embodiments, the conversational-type data can comprise static data, streaming data, and/or data streaming in near-real time.

In one embodiment, the conversational-type data comprises a plurality of utterances as well as a time stamp and/or a sequence position for each utterance. The utterances can be arranged in sequential order according to the time stamp and/or sequence position. Accordingly, an exemplary uniform structure for the conversational-type data arranges each utterance in a delimited field (e.g., a separate line, field, etc.), arranged in the chronological order in which it occurred. The conversational-type data can further comprise basic participant identifying information such as actual names, log-in names, unique number sequences, or some combination of characters, wherein at least some participant identifying information is associated with each of the utterances. In one embodiment, arrangement of the conversational-type data is performed by an ingest engine that receives as input one or more data sources and transforms the data sources into the uniform structure described herein. An exemplary ingest engine assumes that participant identifying information occurs at pre-specified fields within the conversational-type data and the engine works to isolate the information. Suitable ingest engines can perform extraction, transformation and loading and can include, but are not limited to, the Universal Parsing Agent (UPA), and Pacific Northwest National Laboratory's information visualization document analysis software, IN-SPIRE™ (Richland, Wash.). Details regarding the UPA are described in published U.S. Patent Application 2005-0108267A1 and in U.S. patent application Ser. No. 11/330,792, which details are incorporated herein by reference. Additional details regarding IN-SPIRE™ are described by Hetzler and Turner (“Analysis experiences using information visualization,” IEEE Computer Graphics and Applications, vol. 24, no. 5, pp. 22-26, 2004), by U.S. Pat. Nos. 7,113,958, 6,298,174, and 6,584,220, and by U.S. patent application Ser. No. 11/535,360, which details are incorporated herein by reference.

As used herein, extracted information from conversational-type data can refer to pertinent information identified based, at least in part, on characteristics and attributes of the conversational-type data. Accordingly, in addition to the topical segments, exemplary types of extracted information can include, but are not limited to, participants, participant attitudes, participant roles, and named entities.

The participant type of extracted information can be extracted, for example, by an ingest engine, as described elsewhere herein. In such an instance, the participant type of extracted information can be read directly from the conversational-type data. In one embodiment, the ingest engine assumes that participant names occur in a pre-specified field in the input data and isolates each name.

Participant attitudes, as used herein, can refer to the attitudes of participants toward, for example, the topics they discuss and/or the other participants. In one embodiment, participant attitude can be characterized by sentiment, or affect, analysis. For example, automatic sentiment analysis can be performed according to a lexical approach, wherein a lexicon is employed to assign scores to every utterance according to the number of positive and negative words contained therein. The resultant scores can then be used to characterize the affect of topics in general, as well as the general mood of the participants. An exemplary lexicon includes, but is not limited to, the General Inquirer, a computer-assisted approach for content analyses of textual data developed by Philip Stone. Details regarding the General Inquirer are described in “Thematic Text Analysis: New Agendas for Analyzing Text Content” (see “Thematic Text Analysis: New Agendas for Analyzing Text Content”, In C. Roberts (Ed.), Text Analysis for the Social Sciences: Lawrence Erlbaum Associates Inc. (1977)), which details are incorporated herein by reference.

Participant roles, as used herein, can refer to a characterization of the role a participant assumes in a social dynamic and can include, but is not limited to, the position, function, character, status, and relationship, of the participants in a conversation. In one embodiment, participant roles can be determined from textual cues, which can serve as indicators of social roles and intents. Exemplary textual cues can include, but are not limited to, speaker statistics such as the number of utterances, the number of words, the proportion of questions to statements, the proportion of content words to function words, and the number of “unsolicited statements” (e.g., those not preceded by a question mark). Furthermore, lexicons can be used as a source for indicators of personality type, expertise, and/or attitude. For example, the lexical categories in the General Inquirer lexicon, including strong, weak, power cooperative, power conflict, etc. can be used as indicators of participant roles in the conversational setting.

Named entities, as used herein, can refer to designators that stand for a referent. Therefore, exemplary named entities can be “unique identifiers,” including but not limited to, entities (e.g., organizations, persons, objects, deities, locations, etc.), product names, names of diseases or drugs, biological or biochemical names (e.g., plants, organisms, etc.), scientific names of genes or chemicals, times (e.g., dates, times, etc.), and quantities (monetary values, percentages, etc.). In one embodiment, named entity recognition can be implemented using information extraction software such as Cicero Lite from the Language Computer Corporation in Richardson, Tex., which has been modified for conversational-type data and for linking with other types of extracted information. Details regarding Cicero Lite are described by Harabagiu, et al. in “Answer Mining by Combining Extraction Techniques with Abductive Reasoning” (Proceedings of the Twelfth Text Retrieval Conference: 375, 2003), which details are incorporated herein by reference. Alternative and/or functionally equivalent information extraction products and algorithms can be implemented and still fall within the scope of the present invention.

Automatically identifying topical segments can comprise chunking text and/or speech into topically cohesive units. Topical segmentation can be useful, for example, in summarization of a document by topic according to a segment function and/or importance. It can be especially useful for processing long texts having multiple topics for a wide range of natural language applications. Examples of conventional methods for topical segmentation include, but are not limited to, Hearst's TextTiling program, LCSeg, and hierarchical segmentation techniques. While a number of methods for topic segmentation, including some mentioned herein, can be suitable for some embodiments of the present invention, many can be less than optimal because they rely on a lexical cohesion signal that requires smoothing in order to reduce noise. A common smoothing technique utilizes a sliding window to reduce the noise resulting from changes of word choices in adjoining statements, which changes might not indicate topic shifts. Therefore, many conventional methods, while successful in segmenting single-authored and/or content-rich documents, are less than effective when applied to conversational-type data, which typically is sparse in content, has intertwining topics, and lacks topic continuity.

In one embodiment, wherein the conversational-type data comprises a list of utterances arranged according to sequence position values associated with each utterance and a participant name for each utterance, automatic identification of topical segments can comprise applying a windowless technique to determine a cohesion signal that does not rely on a sliding window to achieve the requisite smoothing for an effective segmentation. Determination of the cohesion signal can comprise quantifying the similarity between each neighboring pair of utterances. Then, in an iterative fashion, the most similar neighboring pair can be joined, cohesion of the most similar neighboring pair in each iteration can be recorded, and the similarities of the elements neighboring the most similar neighboring pair, which had been joined and recorded, can be re-quantified. The least similar pair of elements will be joined last. A separate minima finding function can pick the local minima in the cohesion signal which can serve as the segment boundaries.

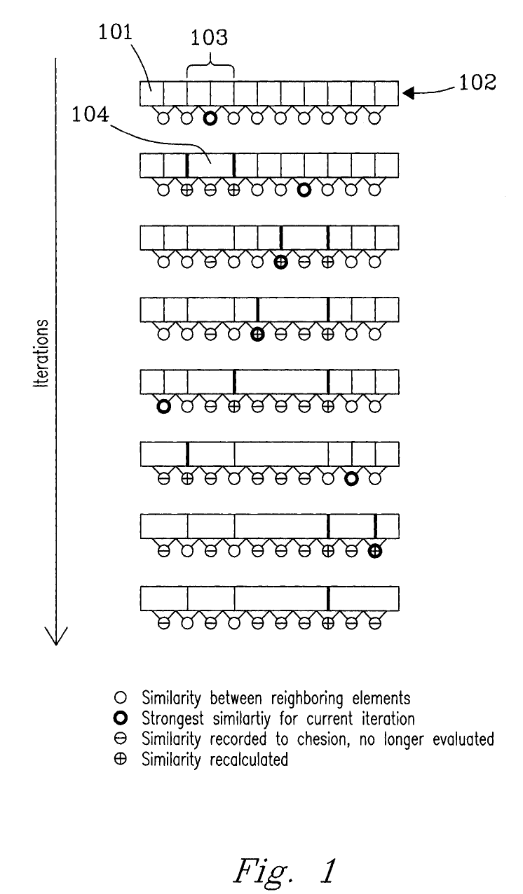

Referring to the embodiment illustrated in FIG. 1, each box (i.e., element node) 101 represents at least one of a plurality of utterances arranged sequentially. The plurality of utterances comprises a conversational-type data document 102 that is analyzed for text segments. A cohesion signal can be calculated by iteratively finding the two most similar neighboring utterances 103 and joining them into a new single element node 104. The similarity between utterances can be quantified by comparing feature vectors associated with each element node. Each time two nodes are joined, their distance is stored in the cohesion signal at their adjoining position. A new feature vector is computed for the parent element node, now considered a single element in the sequence, and the distance to its adjoining elements is recalculated. Again, the two most similar element nodes are found, joined, etc. until each of the elements has been joined. Exemplary distance measures can include, but are not limited to, cosine similarity and jaccard similarity. When all elements have been joined, each of the values in the cohesion signal can be replaced with its cube root. If a typical cohesion signal is viewed as containing the distance between two adjacent windows over the narrative, then according to the instant embodiment, each value in the cohesion signal represents the similarity between two element nodes at the point they were merged, and is thus smoothed by the underlying cohesion of the feature vectors in the sequence. The segment boundaries can then be picked out as the local minima of the cohesion signal.

In one embodiment, the utterance vectors, which can be used for determining correlation between utterances, comprise an aggregation (e.g., average, sum, mininrnum or maximum aggregations) of term vectors describing the similarity of a given term with selected features in the conversational-type data. Term vectors can comprise correlations between one term and each of the remaining terms or selected features. Determination of the correlations between terms can comprise first identifying all positions for the two terms in a pair of terms. An array can then be generated describing all the unique positions of the terms in the pair. A paired value array can then be generated for each term in the pair of terms, wherein for each unique position of one of the paired terms, the next closest position of either term is recorded in its respective paired value array. A correlation value can be determined by providing the two paired value arrays to a correlation function. Exemplary correlation functions can include, but are not limited to Lin's concordance correlation coefficient, Spearman's rank correlation coefficient, and Kendall's tau rank correlation coefficient.

### EXAMPLE

### Calculating Correlations between Terms in the Poem, The Maids of Elfin-Mere

In the instant example, the poem, The Maids of Elfin-Mere, by William Allingham, represents conversational-type data. Referring to Table 1, the structure of the poem is described by position IDs, wherein each line of the poem represents an utterance and is identified by a numeric position ID. Table 1 also contains a list of term IDs corresponding to terms found in each line of text (i.e., utterance). A list of terms and their corresponding term IDs (i.e., a concordance) is summarized in Table 2.

TABLE 1
A table showing text representing conversational-type data,
position IDs, and term IDs. Each line of the poem represents
an utterance in the instant example.

| Position ID | Text | Term ID |
|---|---|---|
| 0 | THE MAIDS OF ELFIN-MERE | [14, 13,] |
| 1 | | |
| 2 | When the spinning-room was here | |
| 3 | Came Three Damsels, clothed in white, | [18,] |
| 4 | With their spindles every night; | [15,] |
| 5 | One and Two and three fair Maidens, | |
| 6 | Spinning to a pulsing cadence, | |
| 7 | Singing songs of Elfin-Mere; | [17, 13,] |
| 8 | Till the eleventh hour was toll'd, | [16,] |
| 9 | Then departed through the wold. | |
| 10 | Years ago, and years ago; | [11, 12, 11, 12,] |
| 11 | And the tall reeds sigh as the wind doth | [5, 6, 7, 8, 9, 10,] |
| | blow. | |
| 12 | | |
| 13 | Three white Lilies, calm and clear, | [18,] |
| 14 | And they were loved by every one; | |
| 15 | Most of all, the Pastor's Son, | [3, 4,] |
| 16 | Listening to their gentle singing, | [17,] |
| 17 | Felt his heart go from him, clinging | |
| 18 | Round these Maids of Elfin-Mere. | [14, 13,] |
| 19 | Sued each night to make them stay, | [15,] |
| 20 | Sadden'd when they went away. | |
| 21 | Years ago, and years ago; | [11, 12, 11, 12,] |
| 22 | And the tall reeds sigh as the wind doth | [5, 6, 7, 8, 9, 10,] |
| | blow. | |
| 23 | | |
| 24 | Hands that shook with love and fear | [2,] |
| 25 | Dared put back the village clock, -- | |
| 26 | Flew the spindle, turn'd the rock, | [1,] |
| 27 | Flow'd the song with subtle rounding, | [0,] |
| 28 | Till the false ‘eleven’ was sounding; | [16,] |
| 29 | Then these Maids of Elfin-Mere | [14, 13,] |
| 30 | Swiftly, softly, left the room, | |
| 31 | Like three doves on snowy plume. | |
| 32 | Years ago, and years ago; | [11, 12, 11, 12,] |
| 33 | And the tall reeds sigh as the wind doth | [5, 6, 7, 8, 9, 10,] |
| | blow. | |
| 34 | | |
| 35 | One that night who wander'd near | [15,] |
| 36 | Heard lamentings by the shore, | |
| 37 | Saw at dawn three stains of gore | [19,] |
| 38 | In the waters fade and dwindle. | |
| 39 | Never more with song and spindle | [0, 1,] |
| 40 | Saw we Maids of Elfin-Mere, | [19, 14, 13,] |
| 41 | The Pastor's Son did pine and die; | [3, 4,] |
| 42 | Because true love should never lie. | [2,] |
| 43 | Years ago, and years ago; | [11, 12, 11, 12,] |
| 44 | And the tall reeds sigh as the wind doth | [5, 6, 7, 8, 9, 10,] |
| | blow. | |

TABLE 2
Summary of various terms from The Maids of
Elfin-Mere and their corresponding term ID.

| Term | termID | positions |
|---|---|---|
| song | 0 | [7, 27, 39] |
| spindle | 1 | [4, 26, 39] |
| love | 2 | [14, 24, 42] |
| pastor's | 3 | [15, 41] |
| son | 4 | [15, 41] |
| tall | 5 | [11, 22, 33, 44] |
| reeds | 6 | [11, 22, 33, 44] |
| sigh | 7 | [11, 22, 33, 44] |
| wind | 8 | [11, 22, 33, 44] |
| doth | 9 | [11, 22, 33, 44] |
| blow | 10 | [11, 22, 33, 44] |
| years | 11 | [10, 21, 32, 43] |
| ago | 12 | [10, 21, 32, 43] |
| elfin-mere | 13 | [0, 7, 18, 29, 40] |
| maids | 14 | [0, 18, 29, 40] |
| night | 15 | [4, 19, 35] |
| till | 16 | [8, 28] |
| singing | 17 | [7, 16] |
| white | 18 | [3, 13] |
| saw | 19 | [37, 40] |

Determination of the correlations between terms can comprise calculating the correlation between each term and all the other terms in the text. Accordingly, for each pair of terms, the positions for each term are identified. Referring to Table 3 below, both “tall” and “reeds” occur at positions 11, 22, 33, and 44. The array describing the unique positions of the terms in the pair, therefore, contains positions 11, 22, 33, and 44. The paired value array for “tall” contains positions 11, 22, 33, and 44, since the first instance of “tall” occurs at position 11 and the next instance of either “tall” or “reeds” occurs at positions 11; the next unique instance of “tall” occurs at position 22 and the closest instance of either “tall” or “reeds” occurs at position 22, and so on. A similar exercise results in a paired value array for “reeds” that also contains positions 11, 22, 33, and 44. When passed to a correlation function, the correlation between “tall” and “reeds” is the value 1.

TABLE 3
Summarizes the positions and paired value arrays
for the terms “tall” and “reeds.”

| | Positions |
|---|---|
| “tall” | [11, 22, 33, 44] |
| “reeds” | [11, 22, 33, 44] |
| Unique Positions | [11, 22, 33, 44] |
| | Paired Value Arrays |
| “tall” | [11, 22, 33, 44] |
| “reeds” | [11, 22, 33, 44] |
| Correlation | 1 |

In another instance, referring to Table 4 below, the term “saw” occurs at positions 37 and 40. The term “years” occurs at positions 10, 21, 32, and 43. The array describing the unique positions of the terms in the pair contains positions 10, 21, 32, 37, 40, and 43. As described elsewhere herein, the paired value arrays for “saw” and “years” are generated by recording, for each unique position of one term in the pair, the closest position less than or equal to that position for the respective term. Accordingly, the paired value array for “saw” contains positions 37, 37, 37, 40, 40, and 40, while the paired value array for “years” contains positions 10, 21, 32, 32, 32, and 43. Passing the paired value arrays to a correlation function results in a correlation value of 0.11 for the terms “saw” and “years.”

TABLE 4
Summarizes the positions and paired value arrays
for the terms “saw” and “years.”

| | Positions |
|---|---|
| “saw” | [37, 40] |
| “years” | [10, 21, 32, 43] |
| Unique Positions | [10, 21, 32, 37, 40, 43] |
| | Paired Value Arrays |
| “saw” | [37, 37, 37, 40, 40, 40] |
| “years” | [10, 21, 32, 32, 32, 43] |
| Correlation | 0.112279 |

The correlation values for all term pair combinations can be used in generating term vectors. For example, the term vector for “tall” can comprise the correlation values for all term pair combinations containing the term “tall.” Term vectors, as described elsewhere herein, comprise, at least in part, the correlation of the term vector's respective term with other terms or selected feature and are used as a basis for measuring similarity among utterances.

In one embodiment, linking of topical segments with other types of extracted information is based, at least in part, on the sequential order of the utterances. The sequential order can be established according to, for example, the time stamp or sequence position associated with each utterance. The association of the time stamp, or sequence position, is maintained during any analysis and/or manipulation of the conversational-type data. Accordingly, after the analysis (e.g., topical segmentation, named entity extraction, affect analysis, etc.), the temporal information (i.e., the time stamp or sequence position) and its association with the utterances and/or analysis results remains intact.

The temporal information can, therefore, serve as the commonality by which various types of extracted information can be linked. The different types of extracted information can be linked in a variety of combinations in view of time. For example, in one embodiment, participants and topical segments are linked by mapping the participants to the topical segments over a given period of time (i.e., a range, or portion, of the sequence). Such a mapping can provide information describing which participants contributed to different topics during the defined time period. As used herein, a topic can refer to a label assigned to a topical segment that characterizes the content of that topical segment. In another embodiment, the participants, participant attitudes, and the topical segments are linked, one with another. Such a linking can provide information describing a participants' general attitude over the entire time period, the participants' attitudes towards specific topics, and the contributions of each participant to each topic. In yet another embodiment, the participants, participant attitudes, participant roles, and the topical segments are linked, one with another. More generally, the topical segments and two or more other types of extracted information are linked.

Furthermore, analysis of the conversational-type data can be focused on a particular period of time (i.e., portion of the data) by selecting a range of time stamp values and/or sequence positions. The ability to focus on particular time periods and/or portions of the data provide control over the granularity of the analysis. For example, with respect to automatic identification of topical segments, the determination of cohesion among elements and/or utterances can be based on associations among the utterances over a limited range of sequence positions, as opposed to the entirety of the conversational-type data. In another example of focusing the analysis, to a particular portion of the conversational-type data, the affect can be calculated for a given time period and recalculated for each subsequently selected time period. More specifically, since the association between the temporal information and the utterances and/or analysis results, the affect score for a participant and/or a topic can be calculated for any selected period of time.

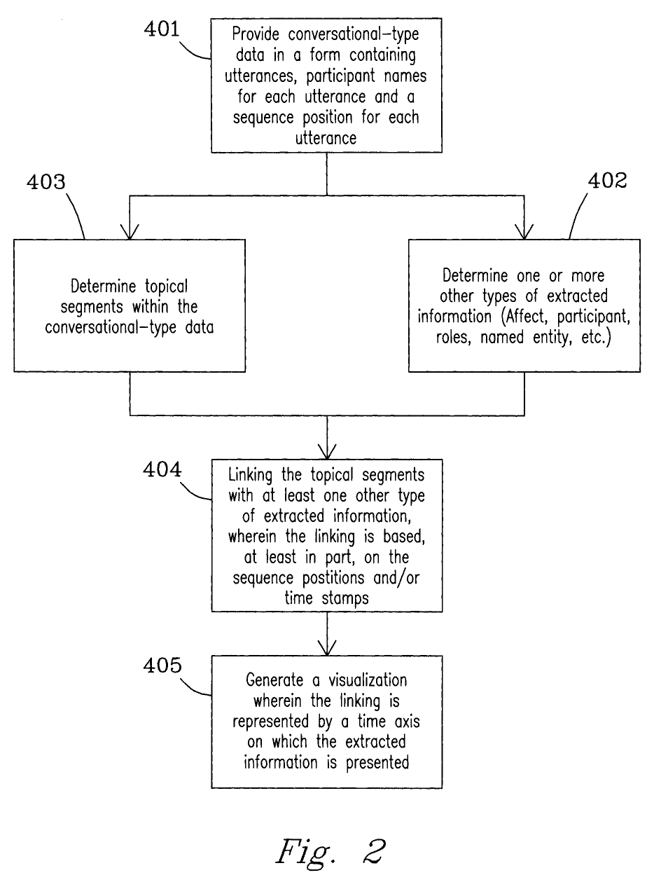

Selection of time periods, viewing of the analysis results, and understanding the temporal linking between different types of extracted information can be aided by a graphical user interface that depicts time. Accordingly, one embodiment of the present invention comprises generating a visualization on a display device. Referring to FIG. 2, an exemplary visualization can provide a matrix-based representation of the linking between extracted information 405, wherein the linking 404 is based, at least in part, on the sequence positions of the utterances. The extracted information within the conversational data can include, but is not limited to, topical segments 402, as well as other types of extracted information 403 such as participants, participant attitudes, participant roles, named entities, etc. As described elsewhere herein, in some embodiments, the conversational-type data can be configured 401 in a structure comprising a list of utterances having participant names and sequence positions associated with each utterance. At least one dimension of the matrix-based representation can comprise a representation of time, or a substantially equivalent representation of the sequential order of the utterances. In some embodiments, the matrix-based representation can be updated in near-real time, which is generally relevant, but particularly suited for streaming conversational-type data.

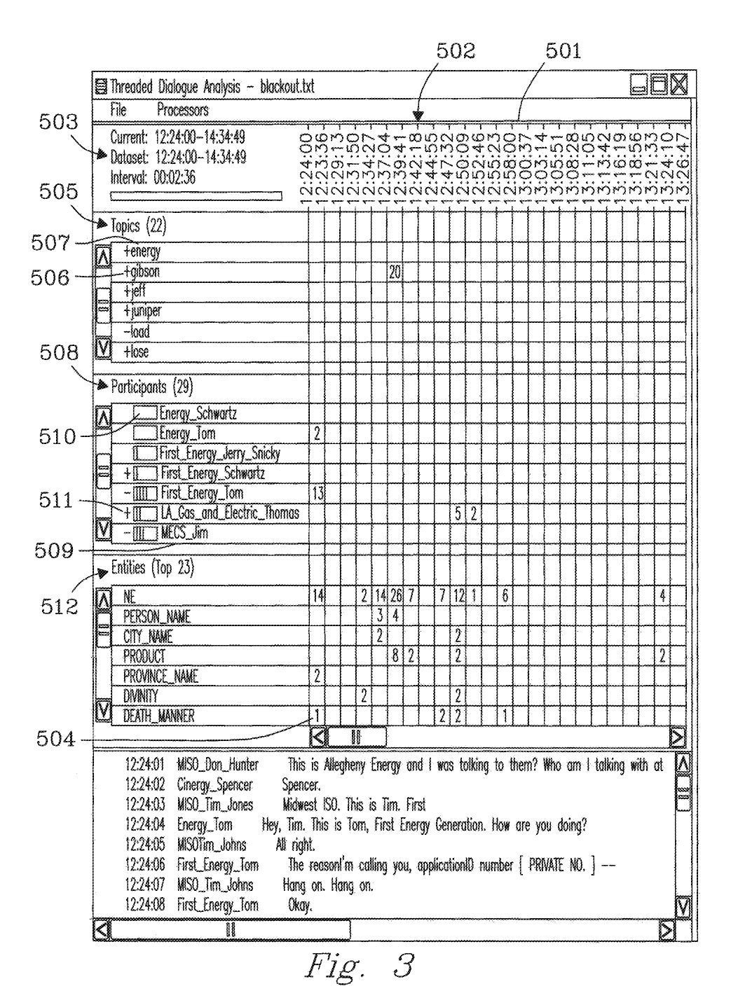

Referring to the embodiment of a user interface (UI) depicted in FIG. 3, the analysis components (e.g., topics or topical segments, participants, named entities, affect, etc.) are all linked through the horizontal x-axis 501, which represents time. Depending on the dataset, positions along the time axis 501 are based on either the time stamps or sequential positions of the utterances. The default time range can be the whole conversation, but a narrower range can be selected by dragging in the interval panel 502 at the upper right portion of the UI. The currently selected time range, the time range covered in the dataset, and the currently selected interval duration is displayed in the upper left portion 503 of the UI. As described elsewhere herein, values for each of the analysis components are recalculated based on the selected time interval. The number of utterances 504 for a given time frame is indicated by the number inside the box corresponding to that time frame, and is recalculated as different time intervals are selected.

In the instant embodiment, the central organizing unit in the UI is topics. The topic panel 505, comprises a color key (not shown), affect scores 506, and topic labels 507. Once a data file is imported into the UI, topic segmentation is performed on the dataset, as described elsewhere herein, and topic labels are assigned to each topical segment. Exemplary topic labels can be derived from the most prevalent word tokens. The user can control the number of words per label. Each topic segment is assigned a color, which is indicated by the color key. The persistence of a color throughout the time axis indicates which topic is being discussed at any given time frame and/or period. Alternatively, pattern labels can be applied.

Affect scores, which can characterize sentiment, are computed for each topic by counting the number of positive and negative affect words in each utterance, that composes a topic, within the selected time interval. Affect can be measured by the proportion of positive to negative words in the selected time interval. If the proportion is greater than zero, the score is positive (represented by a symbol, such as +). If it is less than zero, it is negative (represented by a symbol, such as −). The degree of sentiment can be indicated by varying shades of color on the + or − symbol. Affect can be calculated for both topics and participants. An affect score on the topic panel indicates overall affect contained in the utterances present in a given time interval. The affect score in a participant panel 508 indicates the overall affect in a given participant's utterances for that time interval.

The participant panel 508 comprises speaker labels 509, speaker contribution bars 510, and affect scores 511. The speaker label is displayed in alphabetical order and is grayed out if there are no utterances containing the topic in the selected time interval. The speaker contribution bar, displayed as a horizontal histogram, shows the speaker's proportion of utterances during the time interval. Non-question utterances can be displayed in one color, while utterances containing questions can be displayed in another color. This manner of color labeling information regarding which participant did most of the talking and which had a higher proportion of questions.

The named entity panel 512 comprises a list of entity labels present in the given time interval. The number of instances of each named entity in a given time frame is displayed as a number in the box representing that time frame.

In one embodiment, a message, alert signal, or both can be generated when aspects of the linking between the topical segments and the other types of extracted information satisfy one or more predetermined criteria. The generation of the message, or alert signal, can occur instead of, or in addition to, the generation of the graphic visualization.

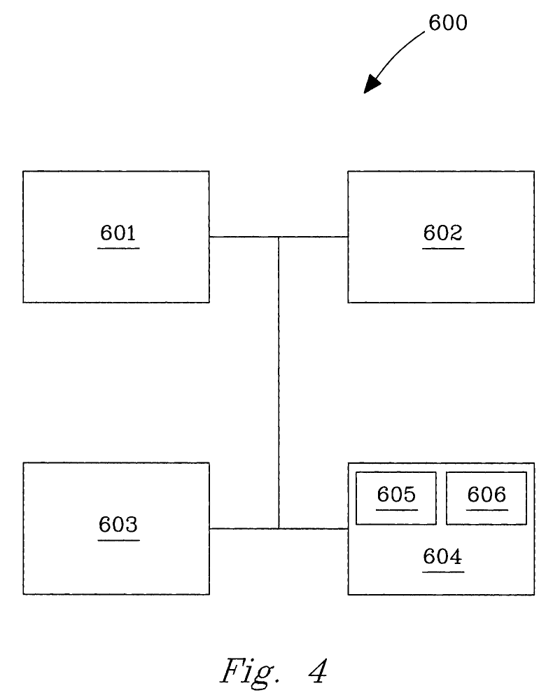

Referring to FIG. 4, an exemplary apparatus 600 for analysis of conversation-type data is illustrated. In the depicted embodiment, the apparatus is implemented as a computing device such as a work station, server, handheld computing device, or personal computer, and can include a communications interface 601, processing circuitry 602, storage circuitry 603, and a user interface 604. Other embodiments of apparatus 600 can include more, less, and/or alternative components.

The communications interface 601 is arranged to implement communications of apparatus 600 with respect to a network, the internet, an external device, a remote data store, etc. Communications interface 601 can be implemented as a network interface card, serial connection, parallel connection, USB port, SCSI host bus adapter, Firewire interface, flash memory interface, floppy disk drive, wireless networking interface, PC card interface, PCI interface, IDE interface, SATA interface, or any other suitable arrangement for communicating with respect to apparatus 600. Accordingly, communications interface 601 can be arranged, for example, to communicate data bi-directionally with respect to apparatus 600.

In an exemplary embodiment, communications interface 601 can interconnect apparatus 600 to one or more persistent data stores having information including, but not limited to, the conversational-type data to be analyzed, data processing algorithms (e.g., topic segrnentation, named entity extraction, affect analysis, etc.), and information analytics algorithms (e.g., visualization and analytical tools) stored thereon. The data store can be locally attached to apparatus 600 or it can be remotely attached via a wireless and/or wired connection through communications interface 601. For example, the communications interface 601 can facilitate access and retrieval of conversational-type data to be ingested and processed from one or more data stores containing processor-usable information. Alternatively, the communications interface can provide a conduit for any variety of sensors to communicate conversational-type data in near-real time.

In another embodiment, processing circuitry 602 is arranged to execute computer-readable instructions, process data, control data access and storage, issue commands, perform calculations, and control other desired operations. Processing circuitry 602 can operate to identify and link topical segments and at least one other type of extracted information within the conversational-type data, wherein the linking is based, at least in part, on a sequential order of the utterances. The processing circuitry 602 can further operate to process conversational-type data inputted into apparatus 600 (e.g., ingest, analytical processing, output results, etc.), and to generate and/or control the user interface (e.g., generate messages, alarms, visualizations, etc.).

Processing circuitry can comprise circuitry configured to implement desired programming provided by appropriate media in at least one embodiment. For example, the processing circuitry 602 can be implemented as one or more of a processor, and/or other structure, configured to execute computer-executable instructions including, but not limited to software, middleware, and/or firmware instructions, and/or hardware circuitry. Exemplary embodiments of processing circuitry 602 can include hardware logic, PGA, FPGA, ASIC, state machines, an/or other structures alone or in combination with a processor. The examples of processing circuitry described herein are for illustration and other configurations are both possible and appropriate.

Storage circuitry 603 can be configured to store programming such as executable code or instructions (e.g., software, middleware, and/or firmware), electronic data (e.g., electronic files, databases, data items, etc.), and/or other digital information and can include, but is not limited to, processor-usable media. Exemplary programming can include, but is not limited to programming configured to cause apparatus 600 to facilitate the analysis of conversational-type data, as described elsewhere herein. Processor-usable media can include, but is not limited to, any computer program product, data store, or article of manufacture that can contain, store, or maintain programming, data, and/or digital information for use by, or in connection with, an instruction execution system including the processing circuitry 602 in the exemplary embodiments described herein. Generally, exemplary processor-usable media can refer to electronic, magnetic, optical, electromagnetic, infrared, or semiconductor media. More specifically, examples of processor-usable media can include, but are not limited to floppy diskettes, zip disks, hard drives, random access memory, compact discs, and digital versatile discs.

At least some embodiments or aspects described herein can be implemented using programming configured to control appropriate processing circuitry and stored within appropriate storage circuitry and/or communicated via a network or via other transmission media. For example, programming can be provided via appropriate media, which can include articles of manufacture, and/or embodied within a data signal (e.g., modulated carrier waves, data packets, digital representations, etc.) communicated via an appropriate transmission medium. Such a transmission medium can include a communication network (e.g., the internet and/or a private network), wired electrical connection, optical connection, and/or electromagnetic energy, for example, via a communications interface, or provided using other appropriate communication structures or media. Exemplary programming, including processor-usable code, can be communicated as a data signal embodied in a carrier wave, in but one example.

User interface 604 can be configured to interact with a user and/or administrator, including conveying information to the user (e.g., displaying data for observation by the user, audibly communicating data to the user, sending messages, generating alarms, etc.) and/or receiving inputs from the user (e.g., tactile inputs, voice instructions, etc.). Accordingly, in one exemplary embodiment, the user interface 604 can include a display device 605 configured to depict visual information, and a keyboard, mouse and/or other input device 606. Examples of a display device include cathode ray tubes, plasma displays, and LCDs.

The embodiment shown in FIG. 4 can be an integrated unit configured for analysis of conversational-type data. Other configurations are possible, wherein apparatus 600 is configured as a networked server and one or more clients are configured to access the processing circuitry and/or storage circuitry for accessing conversational-type data to be analyzed, accessing data processing algorithms, linking different types of extracted information, generating visualizations, conveying analysis results to a user, and receiving input from a user.

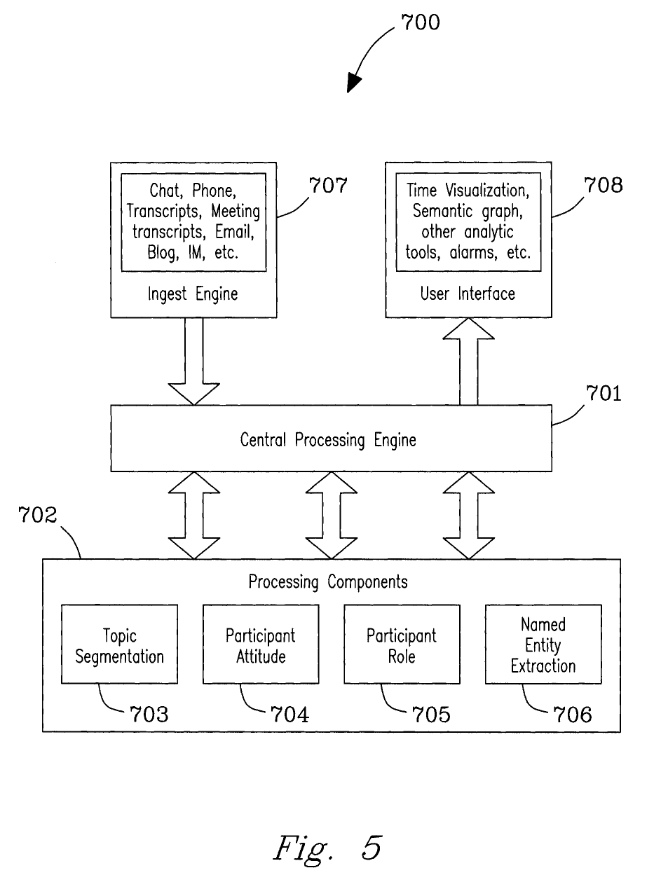

In one embodiment, as depicted by the illustration in FIG. 5, processes executed by the processing circuitry can be arranged according to a modular architecture 700. The modular architecture can comprise a central processing engine 701 and a plurality of processing components 702. The processing components 702 are called by the central processing engine 701 and the central processing engine provides input to, and collects output from, each component. The processing components can comprise, for example, software modules that cause the processing circuitry to perform processes including, but not limited to, topic segmentation 703, sentiment analysis 704, named entity extraction 705, and participant information analysis 706. One or more additional modules can cause the processing circuitry to perform processes related to receiving inputs 707 and generating outputs 708 for a user interface. An exemplary input module ingests conversational-type data to be analyzed. Exemplary output modules can include, but are not limited to, time visualization, semantic graph, and other analytical tools.

Another embodiment of the present invention comprises a computer-readable medium having stored thereon a data structure. The data structure comprises one or more fields containing data representing topical segments within conversational-type data, wherein the conversational-type data comprises a plurality of utterances. The data structure further comprises one or more fields containing data representing other types of extracted information from the conversational-type data, and one or more fields containing data representing a portion of a sequential order of the utterances over which the topical segments and the other types of extracted information are defined. The topical segments and the other types of extracted information are linked, one with another, based, at least in part, on the sequential order of the utterances.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A computer-implemented method for analysis of conversational-type data by association of two or more types of extracted information in view of time, the method comprising
automatically identifying topical segments within the conversational-type data, wherein the conversational-type data comprises a plurality of utterances occurring in a time period; and
linking the topical segments with at least one other type of extracted information from the conversational-type data, wherein the linking is based, at least in part, on a sequential order of the utterances.

2. The computer-implemented method as recited in claim 1, wherein the conversational-type data comprises static data, streaming data, data streaming in near-real time, or combinations thereof.

3. The computer-implemented method as recited in claim 1, occurring in near real-time, for conversational-type data comprising streaming data.

4. The computer-implemented method as recited in claim 1, wherein conversational-type data comprises utterances generated by a plurality of participants engaged in a dialogue.

5. The computer-implemented method as recited in claim 4, wherein the conversational-type data is selected from the group consisting of chat logs, phone transcripts, meeting transcripts, instant messaging, usenet groups, and combinations thereof.

6. The computer-implemented method as recited in claim 1, wherein the conversational-type data is a blog or email correspondence.

7. The computer-implemented method as recited in claim 4, wherein the conversational-type data further comprises a sequence position and a participant name for each utterance, the utterances being arranged according to the sequence position.

8. The computer-implemented method as recited in claim 7, wherein automatically identifying topical segments comprises determining cohesion among the elements in the conversational-type data, the cohesion being based, at least in part, on associations among the utterances over a range of sequence positions.

9. The computer-implemented method as recited in claim 7, wherein automatically identifying topical segments comprises applying a windowless technique for topic segmentation.

10. The computer-implemented method as recited in claim 8, wherein determining cohesion comprises
quantifying the similarity between each neighboring pair of utterances; and
iteratively joining the most similar neighboring pair, recording cohesion of the most similar neighboring pair, and re-quantifying similarities of neighboring elements to the most similar neighboring pair.

11. The computer-implemented method as recited in claim 10, wherein said quantifying is based on utterance vectors of the elements, each utterance vector being a function or aggregation of term vectors describing the similarity of a given term with selected features in the conversational-type data.

12. The computer-implemented method as recited in claim 11, wherein each term vector comprises correlations between one term and each of the remaining terms, and determination of the correlations comprises:
identifying all positions for terms in a pair of terms;
generating an array of all unique positions of the terms in the pair;
generating a paired value array for each term in the pair of terms, wherein for each unique position of one of the paired terms, the next closest position of either term is recorded in its respective paired value array; and
providing the paired value arrays to a correlation function.

13. The computer-implemented method as recited in claim 1, wherein the other type of extracted information comprises named entities.

14. The computer-implemented method as recited in claim 1, wherein the other type of extracted information comprises participants involved in generation of the conversational-type data.

15. The computer-implemented method as recited in claim 14, wherein the linking comprises mapping the participants to the topical segments over a period of time.

16. The computer-implemented method as recited in claim 1, wherein the other type of extracted information comprises participant attitude.

17. The computer-implemented method as recited in claim 16, further comprising linking participants involved in generation of the conversational-type data, the participant attitude, and the topical segments, one with another.

18. The computer-implemented method as recited in claim 1, wherein the other type of extracted information comprises participant roles.

19. The computer-implemented method as recited in claim 1, wherein the topical segments and two or more other types of extracted information are linked and the other types of extracted information are selected from the group consisting of participant attitude, named entities, participants, and participant roles.

20. The computer-implemented method as recited in claim 1, wherein the linking based on a sequential order comprises determining links between the topical segments and the other types of extracted information for a given portion of the sequential order.

21. The computer-implemented method as recited in claim 1, further comprising representing the linking between the topical segments and the other types of extracted information on a display device.

22. The computer-implemented method as recited in claim 21, wherein the representing comprises generating a matrix-based representation.

23. The computer-implemented method as recited in claim 22, wherein at least one dimension of the matrix-based representation comprises a representation of the sequential order.

24. The computer-implemented method as recited in claim 22, further comprising updating the matrix-based representation in real time, or near-real time.

25. The computer-implemented method as recited in claim 1, further comprising generating a message, alert signal, or combination thereof when aspects of the linking between the topical segments and the other types of extracted information satisfy one or more predetermined criteria.

26. An apparatus for analysis of conversational-type data comprising a plurality of utterances, the apparatus comprising processing circuitry configured to identify and link topical segments and at least one other type of extracted information within the conversational-type data, wherein the linking is based at least in part, on a sequential order of the utterances.

27. The apparatus as recited in claim 26, wherein processes executed by the processing circuitry are arranged according to a modular architecture comprising a central processing engine and a plurality of processing components, wherein processing components are called by the central processing engine and the central processing engine provides input to, and collects output from, each component.

28. The apparatus as recited in claim 27, wherein the processing components comprise software modules causing the processing circuitry to perform processes selected from the group consisting of topic segmentation, sentiment analysis, named entity extraction, and participant information analysis.

29. The apparatus as recited in claim 26, further comprising a user interface operably connected to the processing circuitry and configured to display a representation of the linking between the topical segments and the other types of extracted information.

30. The apparatus as recited in claim 29, wherein the representation comprises a matrix-based representation.

31. The apparatus as recited in claim 29, wherein at least one dimension of the matrix-based representation comprises a representation of the sequential order.

32. A computer-readable medium having stored thereon a data structure comprising:
one or more fields containing data representing topical segments within conversational-type data, wherein the conversational-type data comprises a plurality of utterances;
one or more fields containing data representing other types of extracted information from the conversational-type data; and
one or more fields containing data representing a portion of a sequential order of the utterances over which the topical segments and the other types of extracted information are defined, wherein the topical segments and the other types of extracted information are linked, one with another, based, at least in part, on the sequential order of the utterances.
